(19) United States
(12) Patent Application Publication
(10) Pub. No.: US 2009/0026076 A1
(43) Pub. Date: Jan. 29, 2009

(54) NOX SENSOR WITH IMPROVED SELECTIVITY AND SENSITIVITY

(76) Inventor: Jiun-Chan Yang, Columbus, OH (US)

Correspondence Address: CERAMATEC, INC., 2425 SOUTH 900 WEST, SALT LAKE CITY, UT, 84119, US

(21) Appl. No.: 12/032,114

(22) Filed: Feb. 15, 2008

Related U.S. Application Data
(60) Provisional application No. 60/890,342, filed on Feb. 16, 2007.

(51) Int. Cl. G01N 27/26; B32B 37/00; B32B 38/00; B32B 37/12

(52) U.S. Cl. 204/412; 204/424; 156/60; 156/325; 156/280

(57) ABSTRACT

A NOₓ sensor and a method of manufacturing a NOₓ sensor array. The NOₓ sensor includes a base substrate, a plurality of potentiometric sensors, and a plurality of connectors. The plurality of potentiometric sensors are coupled to the base substrate. Each potentiometric sensor generates a potential difference in response to the presence of NO_{X} in a gas specimen. The plurality of connectors are coupled to the plurality of potentiometric sensors. The plurality of connectors connect the plurality of potentiometric sensors to combine the potential differences of the plurality of potentiometric sensors to produce a combined potential difference indicative of a level of NOₓ within an ambient gas specimen. Use of a filter and appropriate temperature control of filter and sensor minimizes interference from contaminants.

### CROSS-REFERENCE TO RELATED APPLICATIONS

This application claims the benefit of U.S. Provisional Application No. 60/890,342, filed on Feb. 16, 2007, which is incorporated by reference herein in its entirety.

### BACKGROUND

Nitrogen oxides (NOₓ) contribute to ground level ozone formation and acid deposition in the form of acidic particles, fog, and rain. Ground level ozone is a key ingredient of urban smog that causes many respiratory problems. Acid deposition, on the other hand, causes acidification of lakes and streams, damage of forest soils, and decay of building materials and paints. The major source of NOₓ is from the combustion of fossil fuels in power plants, vehicles, and airplanes. High temperature NOₓ sensors to optimize combustion and minimize emissions are mandated for many industries, including automotive engine control and development. Various solid-state NOₓ sensing devices and materials are being examined for operation at elevated temperatures. Among these, electrochemical devices using oxygen-ion-conducting yttria-stabilized-zirconia (YSZ) are appropriate for applications at temperatures higher than 500° C. The basis for NOₓ measurement in these devices is based on the difference of NOₓ electrochemistry between the two electrodes on the sensor, which results in an EMF (electromotive force) response. In the presence of oxygen, the chemical reactions on the surface of metal-oxide electrodes and electrolytes compete with electrochemical reactions. In some instances, the catalytic property of the electrode material influences the sensing performance. The development of solid oxide NOₓ sensors is an interdisciplinary study of solid-state electrochemistry and heterogeneous catalysis.

Electrochemical devices usually exhibit response to many different gases, thus minimizing selectivity. For example, on potentiometric solid-oxide sensors, any gas that can react with the oxygen ions in YSZ should generate a signal. In the case of NOₓ detection, the two main components of nitrogen oxides in combustion environments are NO and NO₂. NO₂ tends to be reduced and NO tends to be oxidized, resulting in the generation of opposite signals. Many NOₓ sensors focus on NO since it is the major component of NOₓ at high temperatures. However, in lean-burn conditions, NO₂ is also present in significant, or measurable, amounts. The interference from other reactive species in the combustion environment, including CO, hydrocarbons, as well as NH₃ also may influence performance. Oxygen and water can also act as interfering species. In typical engine exhausts with NOₓ reduction/storage device, the NOₓ concentration is 1 to 10 ppm, in the presence of 20% CO₂, 10% water, 3%O2, 10 ppm NH₃, 1000 ppm hydrocarbons, and 2000 ppm CO.

In order to eliminate the interference from reducing and oxidizing gases, many applications use catalytic filters. In at least on conventional implementation, a platinum-loaded zeolite Y (PtY) filter has good performance on equilibrating NOₓ and oxidizing CO in the presence of oxygen. Zeolite Y may be selected as the support because the Pt nanoclusters stabilized on the high surface area microporous zeolite cages exhibit excellent catalytic properties. The equilibrated NOₓ after the PtY filter may be measured by a YSZ-based sensor with a metal oxide electrode. The zeolite filter is kept at a different temperature from the sensor to produce a signal.

Potentiometric sensors provide a promising approach for NOₓ detection in harsh environments, but typically suffer from interferences with other gases. Potentiometric sensors use two electrodes, and both chemical and electrochemical reactivity at each electrode influence sensor performance.

### SUMMARY

In some embodiments, a Pt electrode is covered with Pt containing zeolite Y (PtY) and WO₃ as two electrode materials. The electrode may be affected by temperature programmed desorption of NO from NOₓ/O₂-exposed PtY and WO₃. In addition, the ability of PtY and WO₃ to equilibrate a mixture of NO and O₂ may vary over a temperature range of about 200-600° C. Significant reactivity differences may be manifest between PtY and WO₃, with the latter being largely inactive toward NOₓ equilibration. With gases passing through a PtY filter, it may be possible to remove interferences from 2000 ppm CO, 800 ppm propane, 10 ppm NH₃, as well as minimize effects of 1˜13% O₂, CO₂, and H₂O. By maintaining a temperature difference between the filter (typically at 400° C.) and the sensor at about 600° C., total NOₓ concentration (NO+NO₂) measurements may be performed. By connecting three sensors in series, in some embodiments, the sensitivity of the sensor system is improved relative to conventional, single-sensor systems.

An embodiment of a NOₓ sensor is described. The NOₓ sensor includes a base substrate, a plurality of potentiometric sensors, and a plurality of connectors. The plurality of potentiometric sensors are coupled to the base substrate. Each potentiometric sensor generates a potential difference in response to the presence of NOₓ in a gas specimen. The plurality of connectors are coupled to the plurality of potentiometric sensors. The plurality of connectors connect the plurality of potentiometric sensors to combine the potential differences of the plurality of potentiometric sensors to produce a combined potential difference indicative of a level of NOₓ within an ambient gas specimen.

In some embodiments, the plurality of connectors are connected to the plurality of potentiometric sensors to connect the plurality of potentiometric sensors in series. In the series configuration, the combined potential difference is a sum of the potential differences of each of the potentiometric sensors. In some embodiments, each of the potentiometric sensors includes a sensing electrode and a reference electrode. In some embodiments, the NOₓ sensor also includes a first electrode lead and a second electrical lead. The first electrical lead is coupled to the sensing electrode of a first potentiometric sensor within the series of potentiometric sensors. The second electrical lead is coupled to the reference electrode of a last potentiometric sensor within the series of attention nitric sensors. In this configuration, the combined potential difference is measurable at the first and second electrical leads.

Additionally, the first and last potentiometric sensors may be connected together directly, or connected via one or more additional, intermediate potentiometric sensors. In one embodiment, the NOₓ sensor includes a third potentiometric sensor coupled between the first and last potentiometric sensors within the series of potentiometric sensors. In this configuration, the sensing electrode of the first potentiometric sensor is connected to the reference electrode of the third potentiometric sensor, and the sensing electrode at the third potentiometric sensor is connected to the reference electrode of the last potentiometric sensor.

In some embodiments, the sensing electrode is tungsten oxide (WO₃). In some embodiments, the reference electrode is platinum (Pt). In some embodiments, the reference electrode is platinum coated with platinum zeolite (PtY). In some embodiments, each of the potentiometric sensors includes an electrolyte substrate. An exemplary electrolyte substrate is an oxygen-ion conducting ceramic. In some embodiments, the electrolyte substrate is yttria-stabilized zirconia (YSZ). In some embodiments, the connectors are platinum. Other embodiments of the NOₓ sensor are also described.

A method for manufacturing a NOₓ sensor array is also described. In one embodiment, the method includes disposing a plurality of electrolyte substrate on a base substrate, disposing a sensor electrode on each electrolyte substrate, and disposing a reference electrode on each electrolyte substrate. The method also includes connecting, in a series configuration, each of the sensing electrodes, other than a first sensing electrode, to corresponding reference electrodes, other than a last reference electrode, on adjacent electrolyte substrates. In other words, the electrodes are connected together in a chain, except for the first and last electrodes, which are used for electrical leads to connect to a controller, or other device.

In some embodiments, the method also includes using a metallic paste disposed electrolyte substrates on a substrate. In some embodiments, the method also includes connecting the electrolyte substrates in series with a plurality of platinum wires. In some embodiments, the method also includes painting the sensing electrode onto the electrolyte substrate. The sensing electrode may be platinum. In some embodiments, the method also includes painting the reference electrode onto the electrolyte substrate. The reference electrode may be tungsten oxide (WO₃). Other embodiments of the method are also described.

A sensing system to measure the NOₓ in a gas specimen is also described. In one embodiment, the system includes a sensor array, a filter, and a plurality of temperature-control devices. The sensor array includes a plurality of NOₓ sensors coupled in series. The sensor array detects a nitrogen oxide compound in the gas specimen. The filter removes a contaminant compound from the gas specimen. The temperature-control devices maintain the gas specimen at a substantially consistent temperature at the sensor array.

In some embodiments, the NOₓ sensors are implemented with substantially similar materials and structures. In some embodiments, each of the NOₓ sensors includes a sensing electrode and a reference electrode. The sensing electrodes and the reference electrodes of the adjacent NOₓ sensors, respectively, are coupled together to produce a combined potential difference indicative of a sum of potential differences of the plurality of NOₓ sensors. In some embodiments, the sensor array also includes a plurality of connectors coupled to the plurality of NOₓ sensors. The connectors connect the plurality of NOₓ sensors in series. In some embodiments, the filter removes the contaminant compound from the gas specimen prior to introduction of the gas specimen at the sensor array. In some embodiments of sensor array is calibrated to detect parts per million (ppm) and sub-ppm quantities in the gas specimen. In some embodiments, the sensor array also generates an electrical potential difference in response to detection of the nitrogen oxide compound. In some embodiments, the temperature-control devices also maintaining a temperature difference between the sensor array and the filter. Other embodiments of the system are also described.

Other aspects and advantages of embodiments of the present invention will become apparent from the following detailed description, taken in conjunction with the accompanying drawings, which are illustrated by way of example of the various principles and embodiments of the invention.

### BRIEF DESCRIPTION OF THE DRAWINGS

FIG. 1 illustrates a schematic block diagram of one embodiment of a NO_{X} sensor testing setup.

FIG. 2A illustrates a schematic diagram of one embodiment of a NOₓ sensor.

FIG. 2B illustrates a schematic diagram of one embodiment of a sensor array with multiple NOₓ sensors.

FIG. 3 illustrates a temperature programmed desorption (TPD) graph depicting nitric oxide (NO) peak absorption in PtY with 5% oxygen (O₂) at room temperature.

FIG. 4 illustrates a graph of NOₓ equilibration as a function of temperature.

FIG. 5 illustrates a TPD graph depicting NO peak absorption in tungsten oxide (WO₃) with 5% O₂ at room temperature.

FIG. 6 illustrates a graph of electromotive force (EMF) vs. log NOₓ at 600° C.

FIG. 7 illustrates a graph of EMF as a function of filter (PtY) temperature.

FIG. 8 illustrates response curves and an EMF-log graph for a single and 3-sensor array.

FIG. 9-11 illustrates a graph depicting response transients of multiple conditions in a sensor test setup.

FIG. 12A illustrates response curves of NO₂ in different oxygen levels.

FIG. 12B illustrates a graph of an EMF-Oxygen level with and without filtration at varying concentrations.

FIG. 13 illustrates a graph of EMF vs. water level in 10% O₂ with a PtY filter.

FIG. 14 illustrates the stability of an NO sensor signal vs. time.

FIG. 15 illustrates a schematic flow chart diagram of depicting one embodiment of a method of making a sensor array with multiple sensors.

Throughout the description, similar reference numbers may be used to identify similar elements.

### DETAILED DESCRIPTION

In the following description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

At least some embodiments use PtY electrodes. In particular, the high chemical reactivity of PtY may be exploited in the sensor design by using PtY/Pt as a reference electrode. Because of the poor chemical reactivity of NOₓ on WO₃, WO₃ may be used as the sensing electrode with the assumption that NOₓ species will reach the WOₓ/YSZ triple-point boundaries chemically unmodified and produce a more sensitive electrochemical response. A combination of the PtY filter with sensors effectively minimizes interferences from 2000 ppm CO, 1000 ppm propane, and 10 ppm NH₃. Other gases including 30% CO₂, 5˜10% H₂O, 1˜13% O₂ also do not cause significant interference. In some embodiments, the signal magnitude can be enhanced by connecting the sensors in series.

Preparation and characterization of sensor materials. A Pt-loaded zeolite Y powder is prepared from Na-exchanged zeolite Y (Si/Al=2.5, Union Carbide, LZY-52) by ion-exchange. 1.0 g of NaY powder is dried at 100° C. for 4 hours followed by mixing with 2.5 mM [Pt(NH₃)₄]C12 (Alfa Aesar) solution. The mixture is stirred overnight at room temperature for ion-exchange. After washing and centrifuging with distilled water several times, the Pt-exchanged powder is dried at 70° C. for 3 hours and then calcined at 300° C. for 2 hours. The heating rate of calcination is set to 0.2° C./min to increase the Pt dispersion by preventing the autoreduction of ammonia ligand. The calcined zeolite is exposed to 5% H₂ to reduce Pt 2⁺ in the zeolite framework to metallic Pt. WO₃ is used from a commercial powder (99.8%, Alfa Asaer) without any further treatment.

A FEI XL30 FEG ESEM may used to investigate the microstructure of PtY and WO₃. A Rigaku Geigerflex X-Ray Powder Diffractometer may be applied to examine the crystal structure of PtY and WO₃. The dispersion of Pt clusters may be inspected by a FEI Tecnai TF-20 transmission electron microscope with the HAADF detector. The Pt loading may be determined with an inductively coupled plasma-optical emission spectroscopy (ICP-OES). The BET surface area may be measured by a Micrometrics ASAP 2020 analyzer.

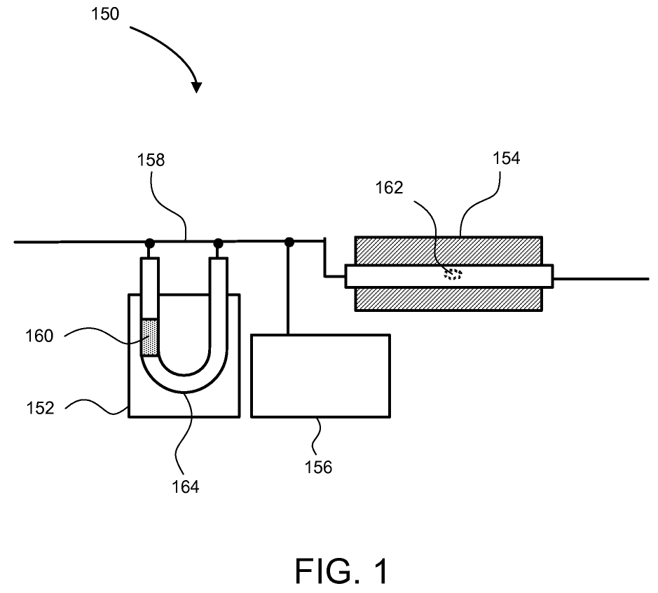

Catalytic NOₓ conversion measurements. FIG. 1 illustrates a schematic block diagram of one embodiment of a NOₓ sensor testing setup 150. Catalytic activity for NOₓ conversion may be measured by a chemiluminescent NOₓ analyzer 156 (Eco-Physics CLD 70S) as shown in FIG. 1. In one embodiment, a 100 mg sample may be placed on a quartz wool support inside a U-shape quartz tube 164 with 4 mm in diameter. The quartz tube 164 may be heated by a vertical tube furnace 152. 600 ppm NO₂, 3% O₂ (balance N₂) may be delivered through the quartz tube 164 at a total flow rate of 200 cc/min and the NOₓ product after reacting with PtY may be examined by the chemiluminescent analyzer 156. As one example, the gas hourly space velocity (GHSV) may be around 90,000 h⁻¹. The NOₓ analyzer 156 may be calibrated daily with 600 ppm or 30 ppm NO primary standards (Praxair) depending on the concentration range of interest. Before evaluating the WO₃ and PtY sample, a blank experiment may be carried out with only quartz wool support to examine the NOₓ conversion from quartz wool and quartz tube 164. Because the purpose of this experiment is to demonstrate the difference in the catalytic activity between PtY and WO₃, as well as examining the NOₓ conversion when PtY was used as a filter 160, the gas flow rate and the mass of sample in the filter 160 should be the same of catalytic and sensor testing.

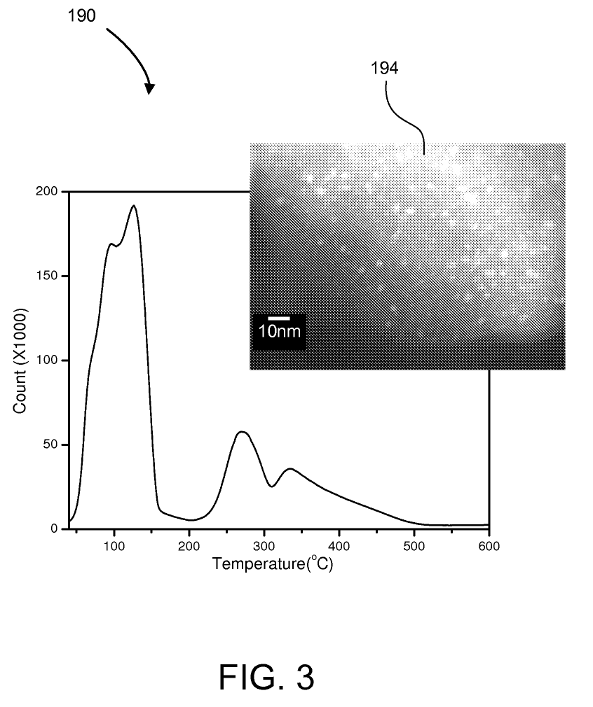

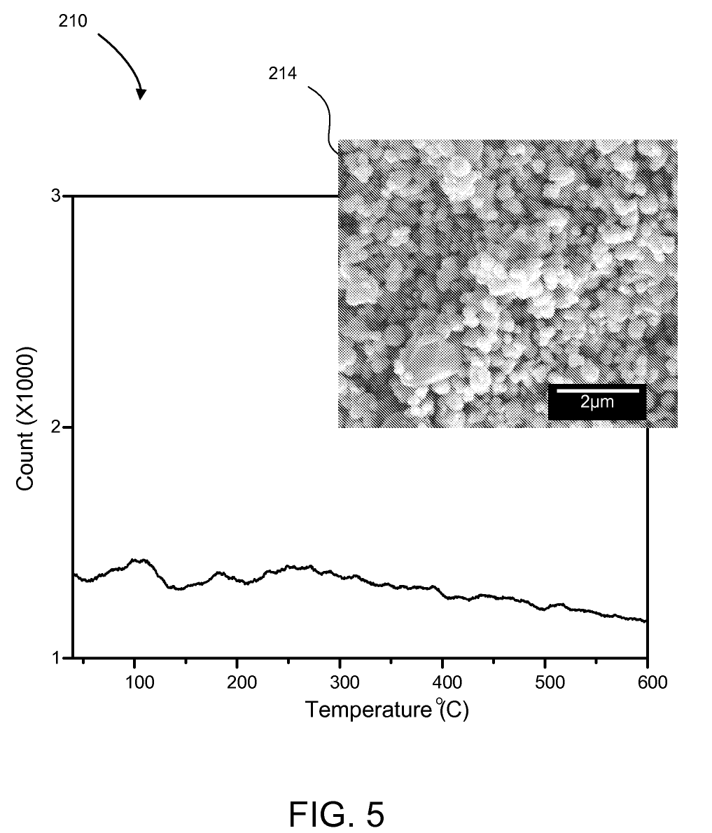

Temperature programmed desorption measurement. Temperature programmed desorption (TPD) may be performed to study the co-adsorption of NO and oxygen on PtY and WO₃. A 300 mg sample may be placed on a quartz wool support inside a U-shape quartz tube 164 (4 mm in diameter). Before gas adsorption, the sample is heated to 650° C. in 10% oxygen for 30 min and cooled down to room temperature in He. 2500 ppm NO and 5% oxygen are passed through the sample tube for 20 min at a flow rate of 60 cc/min for gas adsorption. The sample may be purged with 30 cc/min He for 10 min to remove NOₓ and O₂. The sample temperature then may be increased from room temperature to 600° C. at the rate of 10° C./min. The desorbed species are then analyzed by a gas chromatography-mass spectrometer 156 (Shimadzu QP-5050). In one embodiment, the fragments monitored by the mass spectrometer 156 may be m/z=18(H₂O), 28(N₂ or CO), 30(NO), 32(O₂), 44(N₂O or CO₂), and 46(NO₂). For both PtY and WO₃, only m/z=30 and 46 have notable desorption features. Exemplary data for NO (m/z=30) is shown in FIG. 3 and FIG. 5, since the peak for NO₂ (m/z=46) exhibits similar features.

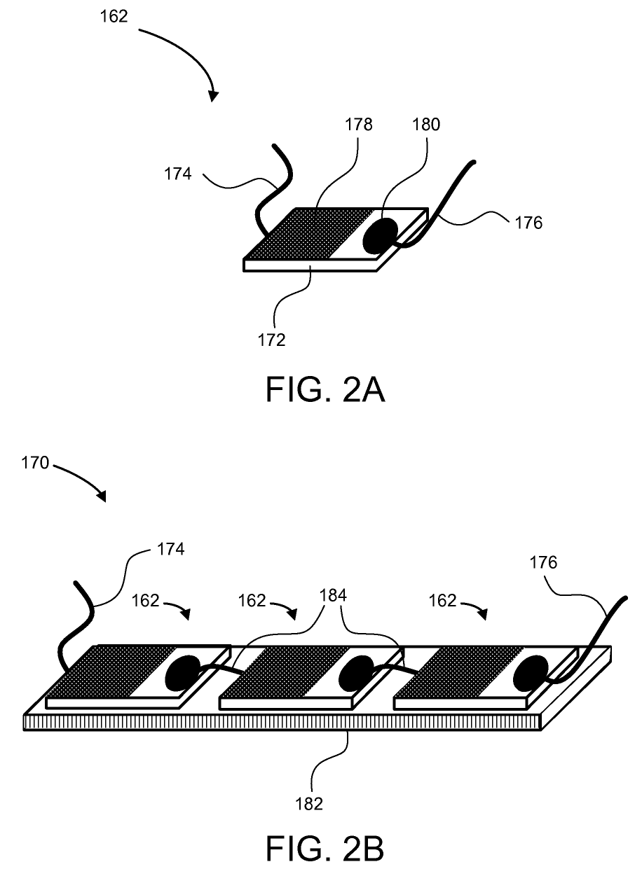

Sensor fabrication. Electrochemical sensors for use in studying the electrodes may be based on YSZ electrolytes 172 with two electrodes 178 and 180, as shown in FIG. 2a. The YSZ substrate 172 is prepared from YSZ green sheets (3 mole % tetragonal YSZ, NexTech Materials). The 10 mm by 5 mm YSZ green sheets are sintered in air at 1450° C. for 2 hours to form dense bodies. Two Pt lead wires 174 and 176 (99.95%, 0.13 mm in diameter, Fischer Scientific) are attached to YSZ 172 with a small amount of commercial Pt ink (Englehard, A4731). In some embodiments, the end attaching to YSZ is shaped into a disc 180 of 2 mm diameter in order to increase the mechanical stability, although other shapes may be used in other embodiments. The Pt ink is cured at 1200° C. for two hours to secure bonding between the Pt wire 176 and YSZ 172. WO₃ powder is mixed with α-terpineol to form a paste, which is then painted on top of the Pt lead wire 174 and YSZ 172. The WO₃ layer 178 is spread over as much YSZ 172 as possible. After sintering at 700° C. in air for 2 hours, the WO₃ layer 178 is about 200 μm thick. PtY is also mixed with α-terpineol and painted on the top of another Pt lead wire 176 to form the reference electrode 180. The PtY layer is around 100 μm thick after calcination in air at 600° C. for two hours.

The sensor array of FIG. 2B is fabricated by connecting three sensors in series. Other embodiments may use two sensors connected in series. Other embodiments may use more than three sensors coupled in series. Other embodiments may use one or more sensors coupled in parallel with one or more sensors coupled in series. As shown in FIG. 2B, YSZ 172 without WO₃ 178 and PtY 180 are attached first on an alumina substrate 182 with gold paste (Heraeus C5789) followed by calcination at 800° C. for 2 hours. Pt wires 184 are used as the interconnect between sensors. The PtY 180 and WO₃ 178 are then applied on the sensors following the method described above.

Gas sensing measurements. Gas sensing experiments may be performed within a quartz tube placed inside a tube furnace 154 (Lindberg Blue, TF55035A). The quartz tube is wrapped with a grounded aluminum foil to screen against electric noise. A computer-controlled gas delivery system with calibrated mass flow controllers (MFC) is used to introduce the test gas stream. Four certified N₂-balanced NOₓ cylinders (30 ppm NO, 30 ppm NO₂, 2000 ppm NO, and 2000 ppm NO₂) are used as NOₓ sources. A pure CO₂ cylinder and certified N₂-balanced 300 ppm NH₃, 2000 ppm CO, and 2000 ppm propane are also connected to the gas delivery system. Certified cylinders may be obtained, for example, from Praxair.

The sensor tests are carried out by mixing dry or humidified air with NOₓ, balancing N₂, and CO/CO₂/NH₃/propane at a total flow rate of 200 cc/min. A pair of Pt wires is used to connect the sensor to the external leads. As schematically shown in FIG. 1, the gas mixture from MFCs could be introduced into the tube furnace either through or bypassing 158 the PtY filter 160. The filter 160 is in a U-shape quartz tube 164 with 100 mg PtY placed on quartz wool, similar as what may be used in the catalytic NOₓ conversion measurements. A chemiluminescent NOₓ analyzer 156 (Eco-Physics CLD 70S) is connected to the outlet of the vertical tube furnace 152 for NOₓ monitoring. The open circuit potential of the sensors is recorded, for example, by a Hewlett-Packard 34970A data acquisition system with 10 GΩ internal impedance. The sensor devices may be conditioned in a 600° C. furnace in air for 15 hours prior to performing sensor tests.

Sensor Design. FIG. 2A illustrates a schematic diagram of one embodiment of a NOₓ sensor 162. The basic sensor design involves the use of two electrodes 178 and 180 on an oxygen-ion conducting ceramic 172, tetragonal yttria-stabilized zirconia (YSZ), across which the potential is measured in the presence of NOₓ species. FIG. 2 shows two exemplary types of sensor devices. FIG. 2a is the basic sensor 162 with two electrodes 180 and 178, including a reference electrode 180 and a sensing electrode 178. As one example, PtY/Pt may be used as the reference electrode 180, and WO₃ may be used as the sensing electrode 178. FIG. 2b depicts a sensor array 170 with three sensors 162 connected in series. In some embodiments, gases pass through a PtY filter 160 placed ahead of the sensor 162 or sensor array 170.

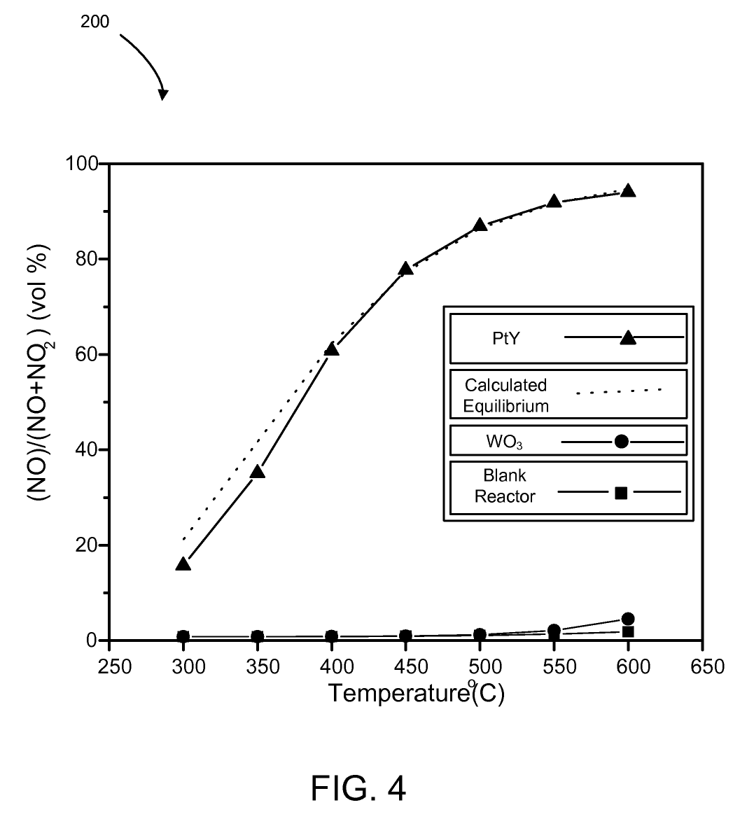

Electrode Materials. Several physical and chemical characteristics of the PtY and WO₃ may be examined. Transmission electron microscopy of PtY shown in the graph 190 of FIG. 3 suggests that Pt clusters are highly dispersed and no clusters larger than 10 nm are found on the exterior of zeolite crystals. The Pt loading determined by elemental analysis (ICP-OES) is 4.36% wt. The surface area of PtY obtained by BET method is 443 m²/g. A sample of PtY is exposed under ambient conditions to NO or NO₂ in 5% O₂. Thermal desorption of NO (peak at m/z=30) may be monitored and data for an exemplary sample 194 exposed to NO is shown in FIG. 3 (similar results may be obtained with samples exposed to NO₂). Four desorption peaks at 100, 128, 270 and 335° C. are observed. The ability of PtY for equilibrating a mixture of 600 ppm NO₂ in 3% O₂ is carried out using the chemiluminescence NOₓ analyzer as the detector (refer to the graph 200 of FIG. 4). The equilibration of NOₓ passing through PtY is complete at temperatures higher than 400° C.

The SEM images 214 in FIG. 5 shows that an average grain size of WO₃ is about 300 nm, and the XRD of WO₃ indicates a monoclinic structure (although the data not shown). The surface area given by the BET method is 2.76 m²/g for WO₃ heated at 700° C. After the co-adsorption of NO(NO₂) and O₂ on WO₃ at room temperature, NO evolution (m/z=30) may be monitored as a function of temperature and the resulting data for NO is shown in the graph 210 of FIG. 5 (NO₂ gives similar results). There is no noticeable desorption of NO. The ability of WO₃ to equilibrate a mixture of 600 ppm NO₂ in 3% O₂ may be studied, and as shown in FIG. 4, there is no significant equilibration of NOₓ even at 600° C.

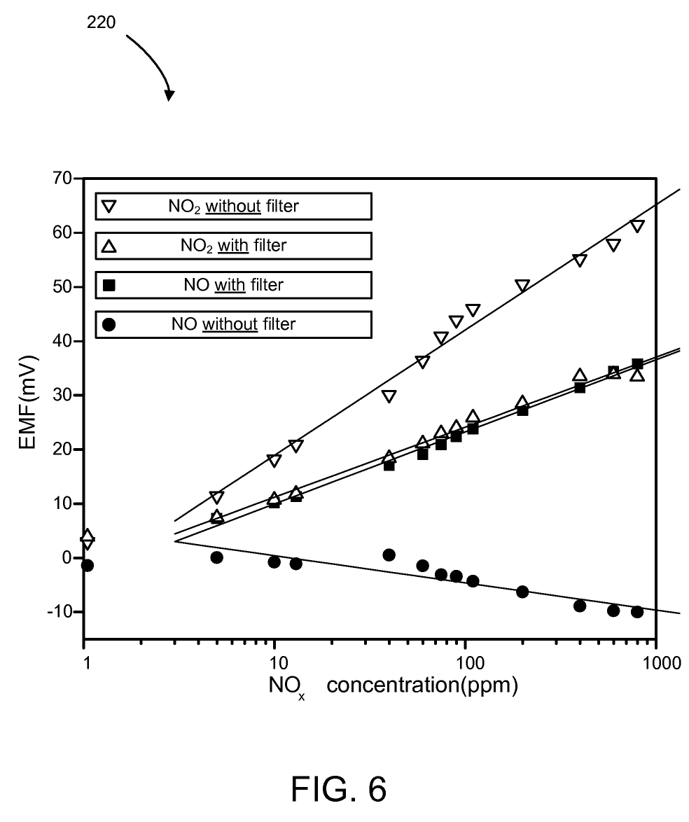

Sensor Characteristics. Sensors may be manufactured, or produced, according to FIG. 2a with WO₃ sensing electrodes 178 and PtY/Pt reference electrodes 180. The change in potential upon exposure to 1-800 ppm NO₂ and NO measured in 3% O₂ may be monitored and the data is shown in the graph 220 of FIG. 6. The potential displays a logarithmic relation to NOₓ concentration. The slope of the NO₂ calibration curve is in the opposite direction as compared to NO.

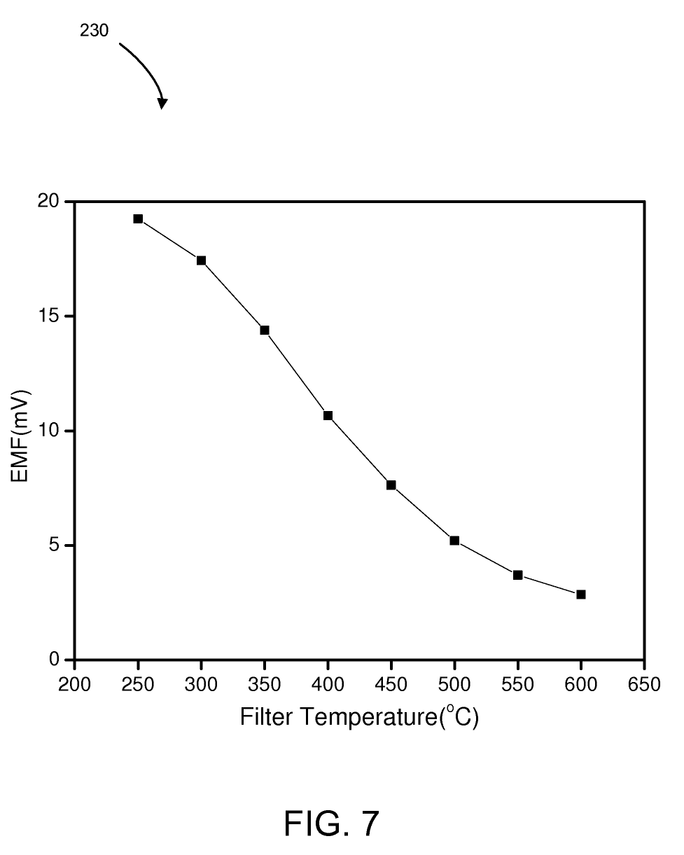

With the gases passing through the PtY filter 160, NO₂ and NO with the same concentration generates almost the same signal on the sensor, as shown in FIG. 6. The calibration curves have better linearity than those without the PtY filter 160. The temperature of the PtY filter 160 may be changed from 250 to 600° C. and the potential may be measured upon exposure of the sensor 162 to 10 ppm NO in 3% O₂. As shown in the graph 230 of FIG. 7, with a larger temperature difference between the filter 160 and the sensor 162, the signal from the sensor 162 is also enhanced.

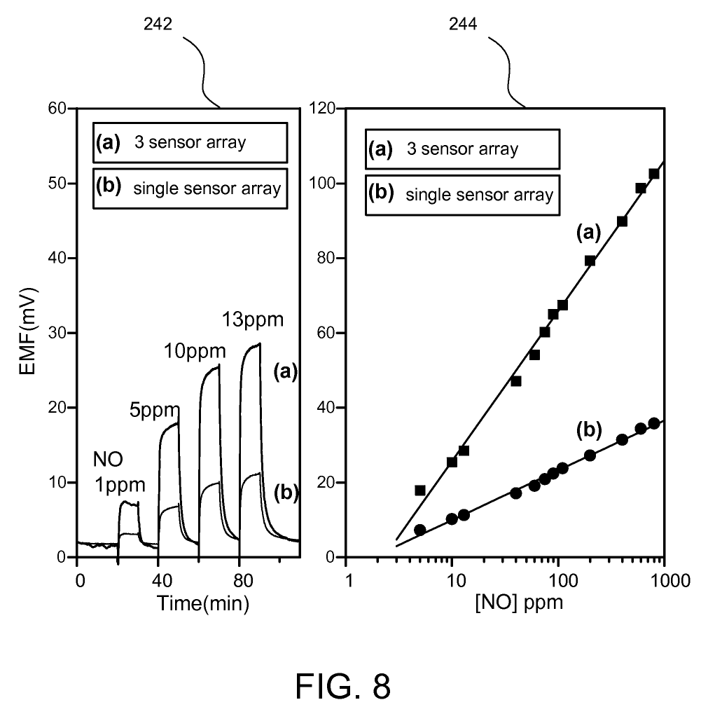

Performance of a single sensor 162 (refer to FIG. 2a) and three sensors 162 linked in series (refer to the sensor array 170 of FIG. 2b) may be compared. The calibration curves 242 and 244 in FIG. 8 show that the signal magnitude is roughly triple for the 3-linked sensor array 170 as compared to a single sensor 162. The increased signal indicates that the EMF is additive by connecting the sensors in series.

Interferences. For cross interference studies, CO, CO₂, NH₃, propane, O₂, and H₂O may be introduced along with NO with and without the gases passing through the PtY filter. During the interference studies, the PtY filter 160 may be maintained at 400° C., and the sensor 162 may be maintained at 600° C. The data is shown for concentrations of NO between 1-13 ppm. Similar results may be obtained for NO₂ if the gases are passed through the PtY filter 162. The relative error is defined as the change in potential with 10 ppm NO in 3% O₂ by itself and in the presence of the interfering gas. Table 1 summarizes exemplary results with the interfering gases.

TABLE 1
Relative changes due to the presence of CO₂, CO, propane, NH₃, oxygen,
and water on NO signal with and without a 400° C. PtY filter.

| | CO₂ | | CO | | Propane | | NH₃ | |
|---|---|---|---|---|---|---|---|---|
| | 20% | 30% | 1500 ppm | 2000 ppm | 500 ppm | 800 ppm | 10 ppm | 50 ppm |
| Without Filter | — | — | −199% | −252% | −821% | −1040% | −299% | −1135% |
| With Filter | 0.9% | 0.2% | 0.2% | −0.3% | −0.5% | 0.1% | 2% | 28% |

| | O₂* | | | H₂O** | | |
|---|---|---|---|---|---|---|
| | 4% | 7% | 10% | 5% | 10% | 15% |
| Without Filter | 73.5% | 39.2% | 16.7% | — | — | — |
| With Filter | 13.2% | 11% | 6.4% | 14.3% | 14.7% | 19.2% |

*Compared with 13.5% oxygen
**Compared with the dry condition

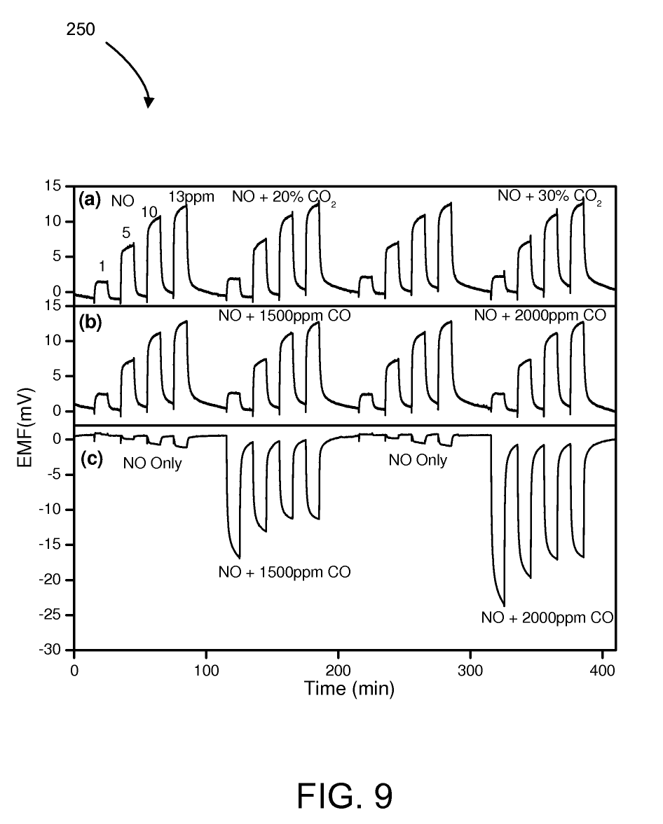

CO₂ and CO interference. The graph 250 of FIG. 9(a) shows exemplary results for NO and NO+CO₂ with gases passing through the PtY filter 160. In particular, four scenarios are shown, with the first and third trace due to NO (1-13 ppm) and the second and fourth traces with NO and 20% and 30% CO₂, respectively. Less than 1% error may be observed for 10 ppm NO in the presence of 20 to 30% CO₂. In the case of CO, substantial interference is noted as shown in FIG. 9(c), with the NO signal completely overwhelmed. When the gas stream is passed through the PtY filter 160, less than 1% difference in signal is observed for 10 ppm NO in the presence of 1500 and 2000 ppm CO, and this data is shown in FIG. 9b.

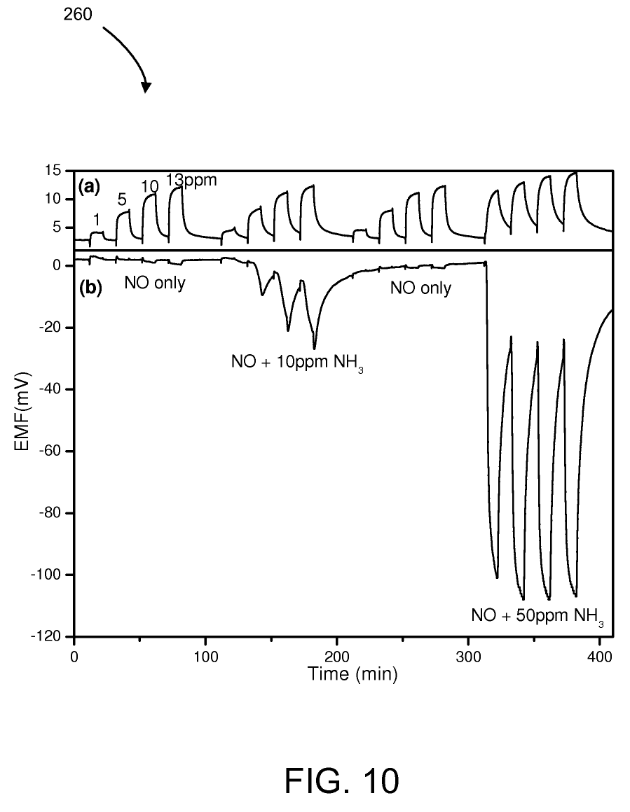

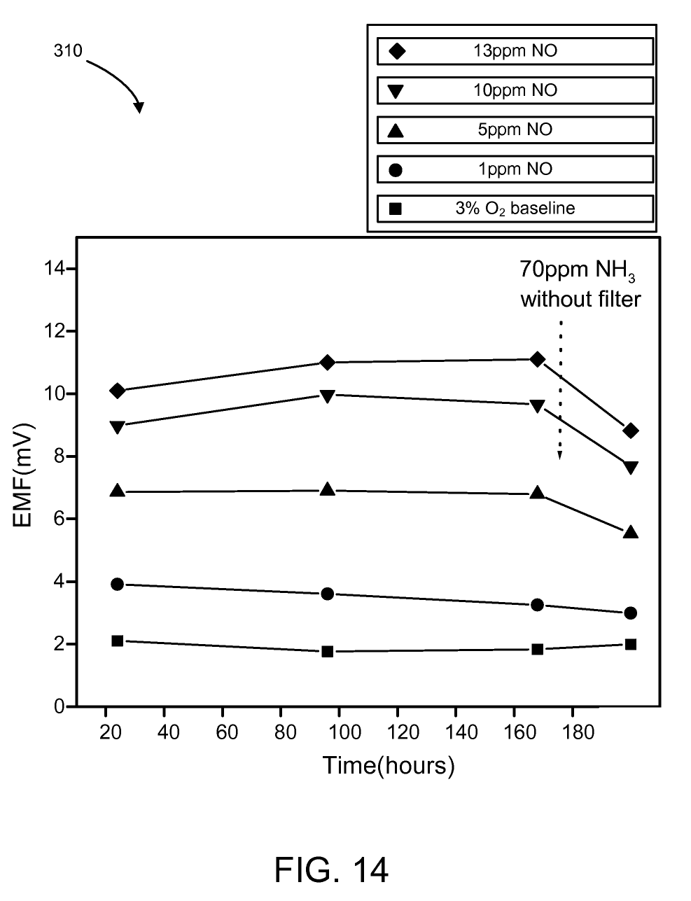

NH₃ interference. FIG. 10b shows that NH₃ produces a strong response, with magnitude of the potential >−100 mV with 50 ppm NH₃ and completely overwhelms the NO signal. An irreversible drop in the NOₓ signal is also observed after passing 70 ppm NH₃ for one hour over the sensor 162 (refer to FIG. 14), indicating that NH₃ modifies the electrode-electrolyte interface. Upon passing 50 ppm NH₃ and NO through the PtY filter 160, 28% error is still observed for 10 ppm NO (refer to FIG. 10a). However, with 10 ppm NH₃, which is the expected level of NH₃ slip from controlled NO reduction/storage devices (e.g., in automobiles), the signal change is ˜2% as long as these gases pass through the PtY filter 160 (refer to the second data set in the graph 260 of FIG. 10a).

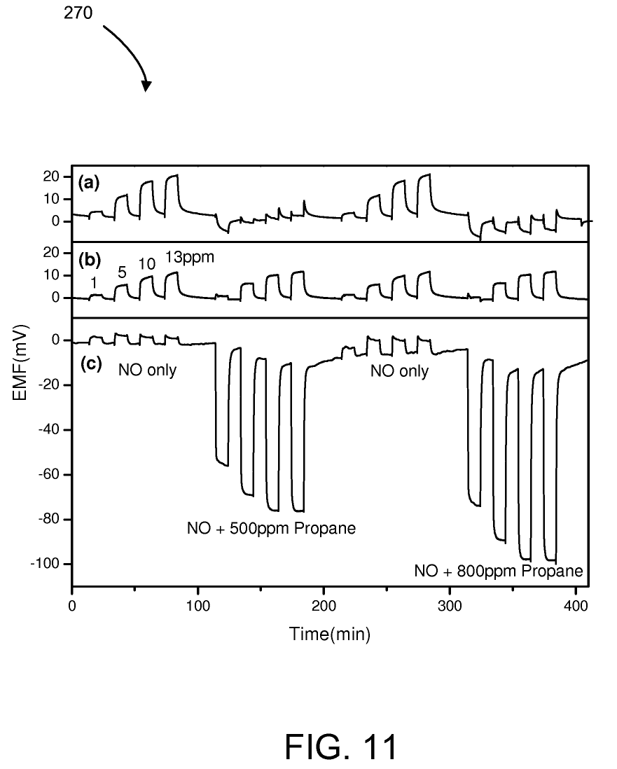

Propane interference. The graph 270 of FIG. 11c shows that 800 ppm propane generates a signal of about −100 mV, significantly higher than NO. Note that the NO only signal is in the opposite direction than what is expected for pure NO (e.g., the first and third sets of data in FIG. 9c), and appears only if propane is tested on the sensor 162 just prior to NO. After switching the gases through a PtY filter 160 at 400° C., 800 ppm propane does not cause significant interference (e.g., <1% for 10 ppm NO; refer to the fourth data set in FIG. 11b). However, the temperature of the PtY filter 160 may influence the ability to reduce or minimize propane interference. FIG. 11 a shows substantial propane interference (e.g., >100% for 10 ppm NO with 500/800 ppm propane; refer to the second and fourth data sets in FIG. 11b) if the PtY filter 160 is maintained at 300° C.

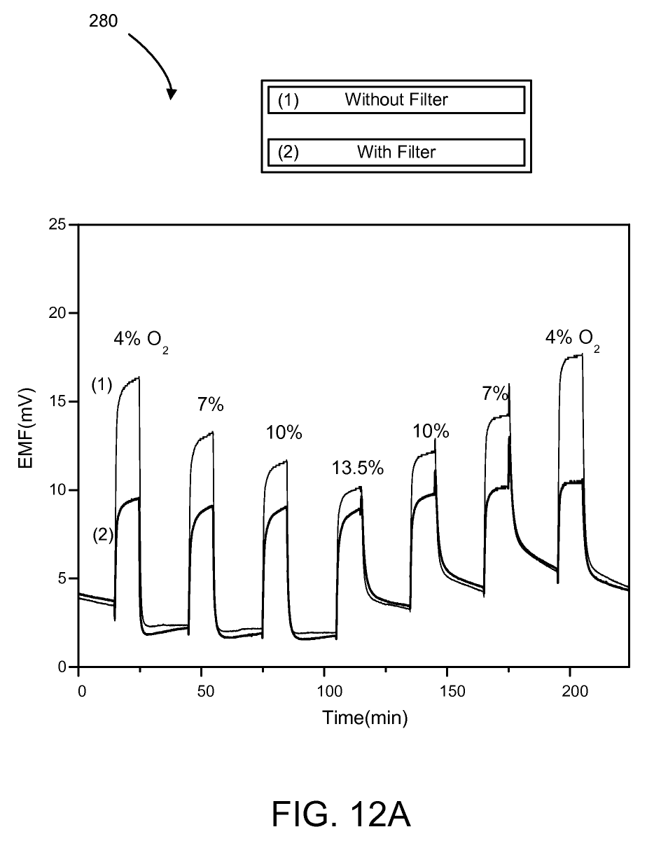

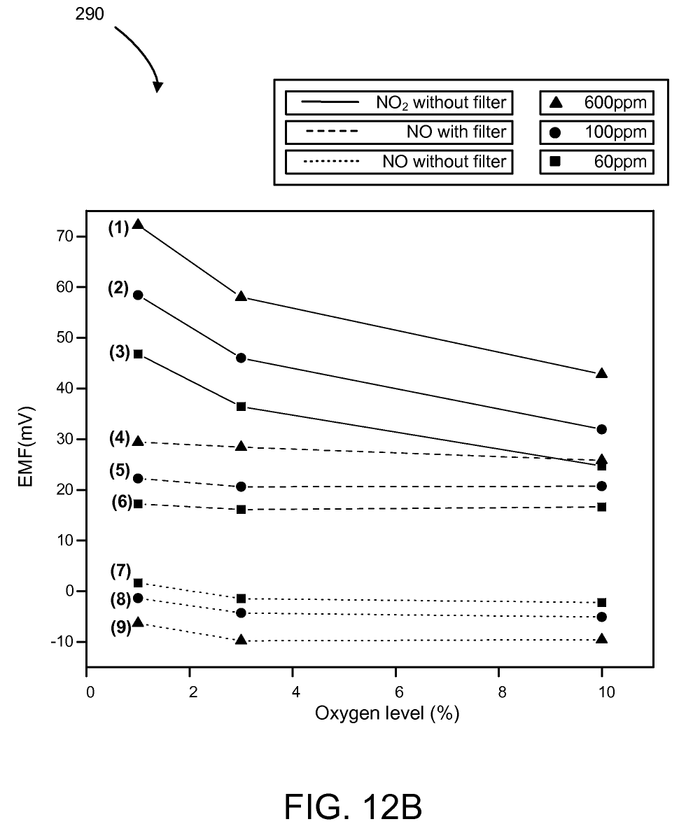

Oxygen interference. The graph 280 of FIG. 12a compares the potential changes with concentration of NO₂ (10 ppm) in varying O₂ concentrations with and without the PtY filter. Plots 1, 2, 3 and 7, 8, 9 in the graph 290 of FIG. 12b demonstrate the effect of oxygen on NO₂ and NO signals without the PtY filter. Plots 4, 5, 6 are for passing NO through the PtY filter. For 60 ppm NO₂, a change of oxygen from 1 to 10% results in 90% relative change in signal. The interference decreases when the PtY filter is applied, as is evident from the graph 280 of FIG. 12a and the graph 300 of 13. The error is 4% for 60 ppm NO (refer to Plot 6) between oxygen levels of 1% and 10%.

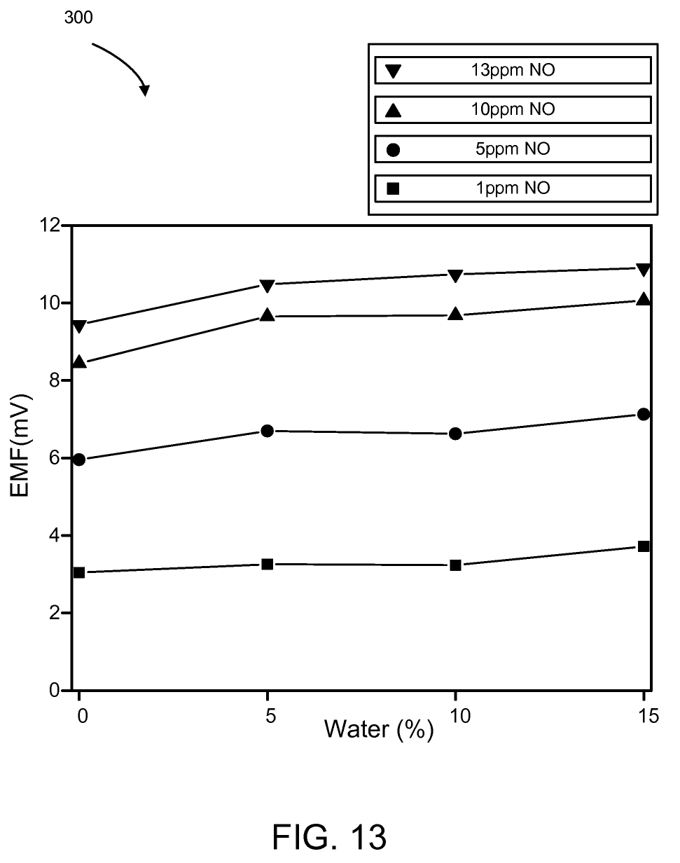

Water interference. In order to examine the effect of water, air may be bubbled through a water bottle and then mixed with other gases. The temperature of the water bottle may be adjusted from 40° C. to 70° C., and the water concentration in the test chamber is calculated from the saturated vapor pressure. FIG. 13 indicates that there is a 14.3% increase in signal for 10 ppm NO when the water level is switched from totally dry to 5% relative humidity. Nevertheless, only 4.5% change is observed from 5% to 15% water. NOₓ equilibration measurements on the PtY filter 160 do not show any change in catalytic activity after being in the stream of 15% water at 400° C. for 2 hours.

Stability. The signal change over a one-week time period is shown in the graph 310 of FIG. 14 for 1-13 ppm NO passing through a PtY filter 160 at 400° C. Tests with 70 ppm NH₃, 2000 ppm CO, and 800 ppm propane may be performed over this period. Overall, the worst-case error is 7.5% for 10 ppm NO. After a 7-day test, 70 ppm NH₃ is passed over the sensor for one hour without the PtY filter 160. A 20% decrease in signal may be observed for 10 ppm NO when the sensor is tested again with the PtY filter 160, and is a permanent effect.

Choice of Electrodes. One embodiment of the sensor structure is shown in FIG. 2, as described above. In some embodiments, no NOₓ electrochemistry occurs at the reference electrode 180, and the sensing electrode 178 is primarily responsible for the sensor signal. In the presence of NOₓ and O₂, the steady-state potential rises when the two redox reactions shown below occur simultaneously on the same electrode:

O₂+4e⁻ [symbol] 2O²⁻ (1)

2NO+2O²⁻ [symbol] 2NO₂+4e⁻ (2)

where O²⁻ represents an oxygen ion on YSZ. The measured potential may be referred as a non-Nernstian or mixed-potential because of the deviation from a typical Nernstian relation. Mixed-potential arises when a nonequilibrium state exists, involving two or more electrochemical reactions, and is the steady-state potential where the partial currents for each reaction (i_{cathodic}+i_{anodic}) is equal to zero.

When NOₓ molecules adsorb on the sensor surface, they can either participate in the charge-transfer reaction (2), and in turn change the open circuit potential, or react with the adsorbed surface oxygen promoting the following reaction:

2NO+O₂ [symbol] 2NO₂ (3)

Reactions (2) and (3) compete with each other. On electrode surfaces where reaction (3) is predominant, NOₓ is brought to thermodynamic equilibrium before the gas reaches the triple-point boundary. Since the NO/NO₂ is already in equilibrium, there is no driving force for the electrochemical reaction. Thus, there is a lack of an electrochemical signal. Such a material is appropriate for the reference electrode 180. In contrast, the sensing electrode 178 for non-Nernstian sensors may have low catalytic activity for reaction (3). This relation is analogous to the anode reaction on solid oxide fuel cells. Non-electrochemical surface reactions could consume the fuel and result in lower open-circuit potential.

Tungsten oxide has low catalytic activity toward NOₓ equilibrium, according to NOₓ conversion measurements and TPD data shown in FIG. 5. Additionally, fully oxidized WO₃ has weak interaction with NOₓ. Typically, nitrosyl species do not form upon NO adsorption on oxides with cations in their highest oxidation state, examples being V⁵⁺, W⁶⁺, and Mo⁶⁺, and is consistent with the TPD data in FIG. 5 for WO₃. On the other hand, W⁴⁺ and W⁵⁺ can form stable nitrosyl species with NOₓ. The absence of NOₓ desorption features on WO₃ also implies that the substoichiometric component is not present in the WO₃. Thus, WO₃ is a good choice for the sensing electrode 178 for potentiometric NOₓ sensing at high temperatures. Other embodiments may use other materials for the sensing electrode 178.

The reference electrode 180 with Pt-loaded zeolite Y promotes reaction (3), and it is likely that NO and NO₂ will reach equilibrium upon passing through the PtY before reaching the triple phase boundary. TPD studies in FIG. 3 show that the coadsorption of NO and O₂ on PtY forms a variety of adsorbed species. Studies on Pt catalysts indicate that the two low temperature desorption peaks (<200° C.) can be attributed as arising from the support, while the peaks around 300° C. are characteristic of the interaction between Pt and NOₓ species. No desorption is noted above 400° C. and so PtY is a good candidate for reference electrode 180. Other embodiments may use other materials for the reference electrode 180.

Total NOₓ sensing. As is clear from plots (b) and (c) in FIG. 6, both NO and NO₂ gives rise to the same calibration curve, essentially functioning as a total NOₓ sensor. When NO or NO₂ passes through the PtY filter 160 in the presence of oxygen, an equilibrium mixture of NO and NO₂ is formed. The NO/NO₂ ratio depends only on the filter temperature when the oxygen level is fixed, as shown in FIG. 4d, (e.g., in 3% oxygen, NO₂ is 37.7% of total NOₓ at 400° C. and only 5.3% at 600° C.). Thus, a NO/NO₂ equilibrated mixture emerging from the PtY filter at 400° C., upon contact with a sensor 162 at 600° C., generates a “NO₂-like” signal as the new equilibrium is attained at 600° C. (NO₂ converting to NO) and is the basis for the total NOₓ sensing, since the filter 160 equilibrates any mixture of NO/NO₂. If the filter 160 is at higher temperatures than the sensor 162, “NO-like” signal is generated.

Interference from Oxidizing Gases. CO, NH₃, and hydrocarbons can react with lattice oxygen ions in YSZ via the following reactions and generate a mixed-potential response, as indicated by the data in FIGS. 9-11.

2CO+2O²⁻ [symbol] 2CO₂+4e⁻ (4)

HₓC_{y}+(x/2+2y)O²⁻ [symbol] (x/2)H₂O+yCO₂+(x+4y)e⁻ (5)

2NH₃+3O²⁻ [symbol] N₂+3H₂O+6e⁻ (6)

Reaction (6) is only one of the possible pathways for the reaction of NH₃. The standard oxidation potential of CO, hydrocarbon, and NH₃ is significantly higher than NO, implying that a small amount of CO, NH₃, or hydrocarbons can totally overwhelm the signal from NOₓ, as noted in FIGS. 9c, 10b, and 11c.

Supported platinum catalysts are known for promoting CO, NH₃, and hydrocarbon oxidation, following the reaction pathways (7)-(9). Again, N₂ formation in reaction (9) is only one of the possible products from NH₃ oxidation.

2CO+O₂ [symbol] 2CO₂ (7)

HₓC_{y}+(x/4+y)O₂ [symbol] (x/2)H₂O+yCO₂ (8)

4NH₃+3O₂ [symbol] 2N₂+6H₂O (9)

In order to minimize interference from CO/propane/NH₃ on the NOₓ signal, in some embodiments, PtY is used to drive reactions (7)-(9) to completion. Also, the reactions between NOₓ and propane/NH₃, often referred as selective catalytic reduction (SCR), may be negligible compared with reactions (8)-(9), since the reaction of NO influence the NOₓ sensor signal.

For NH₃, there may be several oxidization paths. Pt-based catalysts can oxidize NH₃ directly to NOₓ and N₂O with the product ratio depending on the property of catalysts. If NOₓ is produced from NH₃ oxidation, it will increase the signal, and is probably the reason for increase in signal of 28% with 50 ppm NH₃, as shown in FIG. 10a. However, the fact that the signal with 50 ppm NH₃ is not much stronger indicates that N₂ and N₂O may also be forming. In some embodiments, N₂ is not formed at 400° C., suggesting that N₂O may be the primary product when passing through the PtY filter 160. This also implies that N₂O does not generate pronounced signal on WO₃ electrodes at 600° C. Less than 2% error may be observed from 10 ppm NH₃, and would be suitable for most practical applications.

For propane, the temperature window of selective reduction with supported Pt catalysts is about 200-300° C. At 400° C., propane should be oxidized by O₂ instead of NOₓ. As can be seen in FIG. 11b, the PtY filter at 400° C. reduces the error due to 800 ppm propane to less than 1%. However, with the PtY filter 160 at 300° C., the signal observed in FIG. 11a implies that propane might not be fully oxidized, or NOₓ is reduced to N₂/N₂O by SCR reactions. For the Pt-based catalysts at 230° C. under stoichiometric condition, NO even as low as 1 ppm can effectively prohibit propane oxidation.

Another advantage of the reaction of NH₃ on the PtY filter is that it provides protection against electrode microstructure degradation and change of surface stoichiometry caused by reactive NH₃ gas. As can be seen in FIG. 14, exposing the sensor under 70 ppm NH₃ for one hour without the PtY filter 160 may cause permanent decrease in NO signal. Thus, with a PtY filter at 400° C., CO/propane/NH₃ can be converted to less reactive CO₂, H₂O and N₂O. In addition, signal drift is minimal.

Oxygen Interference. Among all gases in the combustion environment, O₂ interference is probably the most difficult to overcome because oxygen is involved in both the ionic conduction process and catalytic NOₓ conversion. The concentration of oxygen is typically more than 100 times higher than NOₓ, and the fluctuation is also large. In many designs of NOₓ sensors, oxygen is pumped out by an additional pair of electrodes to reach a low level before the gas mixture reaches the sensing electrode 162. An additional oxygen sensor may be applied to correct the error from oxygen fluctuations.

For the filter/sensor, the fluctuation of oxygen from 1 to 13.5% shows errors of 4-14% on the NOₓ signal when the PtY filter 160 is applied (refer to FIG. 12b). The use of the PtY filter 160 reduces the oxygen interference since NO/NO₂ equilibration at 400° C. reduces or minimizes the further effect of O₂ reequilibrating the reaction. For example, 100 ppm NO₂ without a filter in 1% O₂ equilibrates at the 600° C. electrode to 3 ppm NO₂/97 ppm NO and at 20% O₂ to 13 ppm NO₂/87 ppm NO, thereby producing a lower signal at the higher O₂ concentrations (refer to FIG. 12a). If the 100 ppm NO first goes through a 400° C. filter, then at 1% O₂, 26 ppm NO₂/74 ppm NO reacts at the 600° C. electrode and, in 20% O₂, the gas mixture is 61 ppm NO₂/39 ppm NO, indicating that the signals are smaller and more comparable, consistent with FIG. 12. This also suggests that the O₂ interference increases as the filter temperature is lowered.

Strategies to Increase Sensitivity. There are two strategies to increase sensitivity in the present filter/sensor design. The first is to increase the temperature difference between the sensor 162 and the filter 160, as shown in FIG. 7. The result can be understood by simple free energy calculations based on reaction (3) and outlined in equation (1). If the filter 160 temperature is at 400° C. and sensor 162 is at 600° C., then the reaction quotient Q in the equation is equal to the equilibrium constant at 400° C. The change in free energy on the surface of a 600° C. sensor 162 can be written as:

$$\begin{matrix}Δ G = Δ {G}_{600}^{°} + RT ln Q \\ = Δ {G}_{600}^{°} + RT ln {K}_{400} \\ = - RT ln {K}_{600} + RT ln {K}_{400}\end{matrix}$$

$$\begin{matrix}Δ G = RT ln ( \frac{{K}_{400}}{{K}_{600}} ) \\ = 34.68 kJ \text{/} mole\end{matrix}$$

The positive value shows that the signal on the sensor 162 is being produced due to the reduction of NO₂ on the sensing electrode 178 (reverse of reaction 3). This value rises as the filter temperature is lowered, leading to a greater driving force for the reaction.

A second method to increase sensitivity is by connecting sensors in series, as exemplified with the three-sensor array shown in FIG. 8. In principle, many potentiometric sensors can be connected in series (analogous to a battery) to increase sensitivity, as long as the internal impedance of the electrometer is high enough to handle the sensor impedance. For low NOₓ detection (e.g., <ppm), a single sensor should generate a measurable response for NOₓ (e.g., ten times the instrument noise level of background). Thus, the proper selection of sensing and reference electrode is useful for developing linked sensors in an array.

Catalytic activity measurements and temperature programmed desorption indicate that WO₃ is almost inactive toward NOₓ equilibration and no chemisorbed NOₓ species are released from the WO₃ surface. On the contrary, PtY has much higher activity toward NOₓ equilibration. The dissimilar catalytic activity of PtY and WO₃ may be exploited to fabricate compact solid-state potentiometric sensors using PtY/Pt as the reference electrode and WO₃ as the sensing electrode. The use of a PtY filter makes it possible to measure total NOₓ. Additionally, interferences from CO, propane, NH₃, H₂O and CO₂ may be reduced or minimized. The PtY filter 160 also provides protection against irreversible changes at the electrode-electrolyte interface from reactions with NH₃. By connecting multiple (e.g., three) sensors in series, the sensitivity is improved by a corresponding factor (e.g., three) and allows for sub-ppm total NOₓ detection.

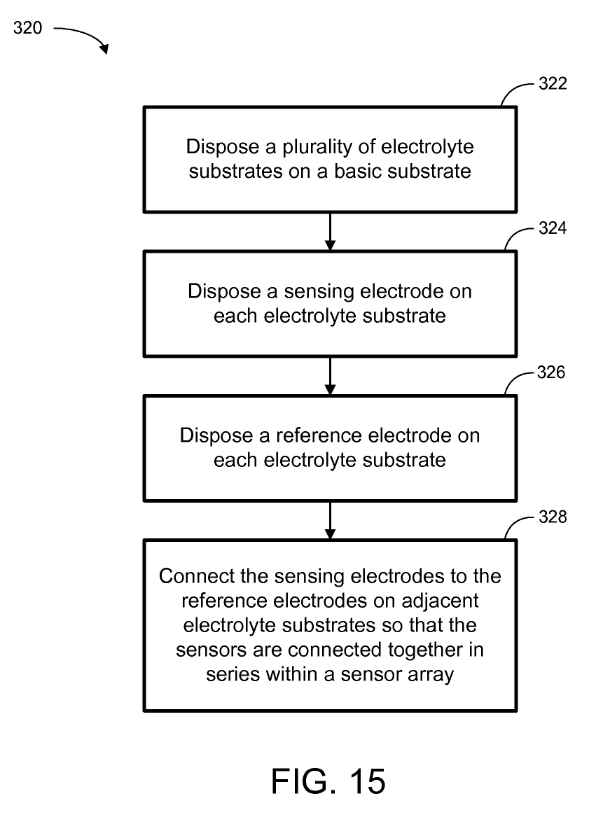

FIG. 15 illustrates a schematic flow chart diagram of depicting one embodiment of a method 320 of making a sensor array with multiple sensors. Although the method 320 is described in conjunction with the sensor of FIG. 2 and the sensor array of FIG. 3, other embodiments of the method 320 may be implemented in conjunction with other sensors and sensor arrays.

In the depicted embodiment, a plurality of electrolyte substrates are disposed 322 on a basic substrate. A sensing electrode is disposed 324 on each electrolyte substrates. A reference electrode is also disposed 326 on each electrolyte substrate. He sensing electrodes are then connected to 328 to the reference electrodes on the adjacent electrolyte substrates so that the sensors are connected together in series within a sensor array. The illustrative method 320 then ends.

Reference throughout this specification to “one embodiment,” “an embodiment,” or similar language means that the described feature, operation, structure, or characteristic may be implemented in at least one embodiment. Thus, the phrases “in one embodiment,” “in an embodiment,” and similar phrases throughout this specification may, but do not necessarily, refer to the same embodiment.

Furthermore, the described features, operations, structures, or characteristics of the described embodiments may be combined in any suitable manner. Hence, the numerous details provided here, such as examples of electrode configurations, housing configurations, substrate configurations, channel configurations, catalyst configurations, and so forth, provide an understanding of several embodiments of the invention. However, some embodiments may be practiced without one or more of the specific details, or with other features operations, components, materials, and so forth. In other instances, well-known structures, materials, or operations are not shown or described in at least some of the figures for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A NOₓ sensor comprising:
a base substrate;
a plurality of sensors coupled to the base substrate, each sensor to generate a potential difference in response to the presence of NOₓ in a gas specimen; and
a plurality of connectors coupled to the plurality of sensors, the plurality of connectors to connect the plurality of sensors to combine the potential differences of the plurality of sensors to produce a combined potential difference indicative of a level of NOₓ within an ambient gas specimen.

2. The NOₓ sensor of claim 1, wherein the plurality of sensors comprises a plurality of potentiometric sensors.

3. The NOₓ sensor of claim 2, wherein the plurality of connectors are connected to the plurality of potentiometric sensors to connect the plurality of potentiometric sensors in series, wherein the combined potential difference comprises a sum of the potential differences of each of the potentiometric sensors.

4. The NOₓ sensor of claim 3, wherein each of the potentiometric sensors comprises a sensing electrode and a reference electrode.

5. The NOₓ sensor of claim 4, further comprising:
a first electrical lead coupled to the sensing electrode of a first potentiometric sensor within the series of potentiometric sensors; and
a second electrical lead coupled to the reference electrode of a last potentiometric sensor within the series of potentiometric sensors;
wherein the combined potential difference is measurable at the first and second electrical leads.

6. The NOₓ sensor of claim 5, further comprising a third potentiometric sensor coupled between the first and last potentiometric sensors within the series of potentiometric sensors, wherein the sensing electrode of the first potentiometric sensor is connected to the reference electrode of the third potentiometric sensor, and the sensing electrode at the third potentiometric sensor is connected to the reference electrode of the last potentiometric sensor.

7. The NOₓ sensor of claim 6, wherein the sensing electrode comprises tungsten oxide (WO₃).

8. The NOₓ sensor of claim 4, wherein the reference electrode comprises platinum (Pt).

9. The NOₓ sensor of claim 8, wherein the reference electrode comprises platinum (Pt) coated with platinum zeolite (PtY).

10. The NOₓ sensor of claim 2, wherein each of the potentiometric sensors comprises an electrolyte substrate, wherein the electrolyte substrate comprises an oxygen-ion conducting ceramic.

11. The NOₓ sensor of claim 10, wherein the electrolyte substrate comprises yttria-stabilized zirconia (YSZ).

12. The NOₓ sensor of claim 2, wherein the plurality of potentiometric sensors comprises at least three potentiometric sensors.

13. The NOₓ sensor of claim 2, wherein each of the connectors of the plurality of connectors comprises platinum (Pt).

14. A method for manufacturing a NOₓ sensor array, the method comprising:
disposing a plurality of electrolyte substrates on a base substrate;
disposing a sensing electrode on each electrolyte substrate;
disposing a reference electrode on each electrolyte substrate; and
connecting, in a series configuration, each of the sensing electrodes, other than a first sensing electrode, to corresponding reference electrodes, other than a last reference electrode, on adjacent electrolyte substrates.

15. The method of claim 14, further comprising using a metallic paste to dispose the electrolyte substrates on the base substrate.

16. The method of claim 14, connecting the electrolyte substrates in series with a plurality of platinum (Pt) wires.

17. The method of claim 14, painting the sensing electrode onto the electrolyte substrate, wherein the sensing electrode comprises platinum (Pt).

18. The method of claim 14, painting the reference electrode onto the electrolyte substrate, wherein the reference electrode comprises tungsten oxide (WO₃).

19. A sensing system to measure NOₓ in a gas specimen, the sensing system comprising:
a sensor array comprising a plurality of NOₓ sensors coupled in series, the sensor array to detect a nitrogen oxide compound in a gas specimen;
a filter to remove a contaminant compound from the gas specimen; and
a plurality of temperature-control devices to maintain the gas specimen at a substantially consistent temperature at the sensor array.

20. The sensing system of claim 19, wherein the plurality of NOₓ sensors comprise substantially similar materials and structures.

21. The sensing system of claim 20, wherein each of the NOₓ sensors comprises a sensing electrode and a reference electrode, and wherein the sensing electrodes and the reference electrodes of the adjacent NOₓ sensors, respectively, are coupled together to produce a combined potential difference indicative of a sum of potential differences of the plurality of NOₓ sensors.

22. The sensing system of claim 21, wherein the sensor array further comprises a plurality of connectors coupled to the plurality of NOₓ sensors, the plurality of connectors to connect the plurality of NOₓ sensors in series.

23. The sensing system of claim 19, wherein the filter is further configured to remove the contaminant compound from the gas specimen prior to introduction of the gas specimen at the sensor array.

24. The sensing system of claim 19, wherein the sensor array is calibrated to detect parts per million (ppm) and sub-ppm quantities in the gas specimen.

25. The sensing system of claim 19, wherein the sensor array is further configured generate an electrical potential difference in response to detection of the nitrogen oxide compound.

26. The sensing system of claim 19, wherein the plurality of temperature-control devices are further configured to maintain a temperature difference between the sensor array and the filter.
